(19) United States
(12) Patent Application Publication
(10) Pub. No.: US 2024/0410436 A1
(43) Pub. Date: Dec. 12, 2024

(54) Adaptive directional springs (ADS) and self-learning mechanical circuits

(71) Applicant: The Board of Trustees of the Leland Stanford Junior University, Stanford, CA (US)

(72) Inventors: Manu Prakash, San Francisco, CA (US); Vishal Prakash Patil, Stanford, CA (US); Ian Ho, Stanford, CA (US)

(21) Appl. No.: 18/424,176

(22) Filed: Jan. 26, 2024

Related U.S. Application Data
(60) Provisional application No. 63/441,729, filed on Jan. 27, 2023.
(60) Provisional application No. 63/623,505, filed on Jan. 22, 2024.

(51) Int. Cl. F16F 3/02

(52) U.S. Cl. CPC F16F 3/02; F16F 2228/066; F16F 2230/18

(57) ABSTRACT

A method of self-learning mechanical circuits is provided. The mechanical circuit takes mechanical inputs from changing environments and constantly update its internal state in response, thus representing an entirely mechanical information processing unit.

### CROSS-REFERENCE TO RELATED APPLICATIONS

This application claims priority from U.S. Provisional Patent Application 63/441,729 filed Jan. 27, 2023, which is incorporated herein by reference. This application claims priority from U.S. Provisional Patent Application 63/623,505 filed Jan. 22, 2024, which is incorporated herein by reference.

### FIELD OF THE INVENTION

This invention relates to self-learning mechanical circuits.

### BACKGROUND OF THE INVENTION

Mechanical principles guide continual autonomous adaptivity in a range of active systems. In living materials from cells to swarms, the reorganization of active components have functional mechanical consequences, determining cellular contractility, screening stress and encoding memory. Using external computational optimization, abiotic tunable materials, including amorphous solids and deformable sheets, can be constructed to have de-sired mechanical properties, such as the ability to function as a classifier. Although certain adaptive materials can solve optimization problems using the principles of dynamical systems, current implementations of material computation lack the ability to self-learn. On the other hand, biological adaptive matter responds autonomously and continually to changing environments, without the need for a central controller or an external reset. This raises the question of whether distributed, self-learning behavior can be embedded in the intrinsic dynamics of a battery-free mechanical systems. Such purely mechanical forms of adaptivity, in which sensing and actuation are directly encoded in the mechanical domain, provide advantages for building monolithic, self-regulating structures.

In this invention, the concept of self-learning mechanical circuits is introduced, where circuits interact with their environment mechanically, and continually update their internal state as the environment changes.

### SUMMARY OF THE INVENTION

A method of self-learning mechanical circuits is provided. The mechanical circuit takes mechanical inputs from changing environments and constantly update its internal state in response, thus representing an entirely mechanical information processing unit. The circuits are composed of a mechanical construct: an adaptive directed spring (ADS), which changes its stiffness in a directional manner, enabling neural network-like computations. The inventors teach a foundation and experimental realization of these elastic learning units and demonstrate the ability to autonomously uncover patterns hidden in environmental inputs. Results pave the way towards the construction of energy-harvesting, adaptive materials which can autonomously and continuously sense and self-optimize to gain function in different environments.

### DETAILED DESCRIPTION

Embodiments and examples are provided in U.S. Provisional Patent Application 63/441,729 filed Jan. 27, 2023, which is incorporated herein by reference and U.S. Provisional Patent Application 63/623,505 filed Jan. 22, 2024, which is also incorporated herein by reference.

What is claimed is:

1. A method for self-learning a mechanical circuit, comprising:
(a) having a mechanical circuit embedded in a device, wherein the mechanical circuit takes mechanical inputs from an environment interacting with the device, and wherein the mechanical circuit is made up of a network of adaptive directed springs with an internal spring stiffness pattern; and
(b) updating the internal spring stiffness pattern in response the mechanical inputs, wherein the updating is based on a neuronal dynamic model capable of self-learning and optimizing the mechanical circuit for interactions of the device with the environment.
